(19) United States
(12) Patent Application Publication
(10) Pub. No.: US 2018/0293347 A1
(43) Pub. Date: Oct. 11, 2018

(54) INTAKE DESIGNING METHOD, NON-TRANSITORY COMPUTER READABLE MEDIUM, AND INTAKE DESIGNING APPARATUS

(71) Applicant: SUBARU CORPORATION, Tokyo (JP)

(72) Inventors: Takeshi OSUKA, Tokyo (JP); Kazushige SATO, Tokyo (JP); Chikage MURAKAMI, Tokyo (JP); Tomoyuki OKITA, Tokyo (JP)

(21) Appl. No.: 15/945,582

(22) Filed: Apr. 4, 2018

(30) Foreign Application Priority Data
Apr. 11, 2017 (JP) 2017-077903

(51) Int. Cl. G06F 17/50; F02C 7/04

(52) U.S. Cl. CPC G06F 17/5095; G06F 2217/46; F05D 2260/81; F02C 7/04

(57) ABSTRACT

An intake designing method includes: setting a value of a design parameter related to a design target that is directed to a front fuselage, a bump, and an intake duct of an aircraft; setting a shape of the design target on the basis of the set value of the design parameter; analyzing an aerodynamic characteristic and a radar cross-section characteristic of the design target on the basis of the set shape of the design target; determining whether an analysis result obtained by the analyzing satisfies a preset design condition; updating the value of the design parameter when the analysis result obtained by the analyzing is determined as not satisfying the design condition; and repeating the setting the shape of the design target, the analyzing, the determining, and the updating the value of the design parameter, until the analysis result obtained by the analyzing is determined as satisfying the design condition.

### CROSS-REFERENCE TO RELATED APPLICATIONS

The present application claims priority from Japanese Patent Application No. 2017-077903 filed on Apr. 11, 2017, the entire contents of which are hereby incorporated by reference.

### BACKGROUND

The technology relates to a technique directed to designing of a diverterless intake having a bump.

Dealing with a boundary layer is important in designing of an intake or an “air inlet” of an aircraft. The boundary layer develops on a surface of an airframe in a region in front of the intake, and is an airflow that has lost its energy due to friction with the surface of the airframe. When the boundary layer flows into the intake and is supplied to an engine, a concern such as a decrease in engine performance may possibly arise.

A technique employing a diverter, i.e., a boundary layer partition, has been known as one of techniques that prevent the boundary layer from flowing into the intake. The technique provides a gap between the intake and a surface of the airframe, and disposes the diverter at the gap. The gap is about a thickness of the boundary layer. While the technique employing the diverter allows only airflow outside the boundary layer to flow into the intake, a concern may possibly arise such as a decrease in airframe performance due to weight and air resistance of the diverter itself.

To address such a concern, a technique employing a diverterless intake has been proposed and put into practical use in recent years as one of techniques that remove the boundary layer without resorting to the diverter. The technique provides a bump or a “protrusion” on a surface of an airframe in a region in front of the intake, as disclosed in U.S. Pat. No. 5,779,189, for example. The diverterless intake removes the boundary layer to the side of the intake owing to a pressure gradient created on the bump, while avoiding sudden deceleration resulting from a shock wave and suppressing a loss of flow energy by means of the bump.

In designing of the diverterless intake, a shape of the bump is determined through setting a compression surface on the basis of a streamline that follows along a front fuselage under preset flight conditions, and setting a connection that becomes continuous with the compression surface in such a manner that desired aerodynamic characteristics are satisfied.

### SUMMARY

An aspect of the technology provides an intake designing method that designs a shape of an intake of an aircraft. The method includes: setting a value of a design parameter that is related to a design target on a basis of an input operation, in which the design target is directed to a front fuselage, a bump, and an intake duct of the aircraft, the front fuselage is positioned more forward of an airframe of the aircraft than the intake, and the bump is positioned in front of the intake; setting a shape of the design target on a basis of the set value of the design parameter; analyzing an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target; determining whether an analysis result obtained by the analyzing satisfies a preset design condition; updating the value of the design parameter when the analysis result obtained by the analyzing is determined by the determining as not satisfying the design condition; and repeating the setting the shape of the design target, the analyzing, the determining, and the updating the value of the design parameter, until the analysis result obtained by the analyzing is determined by the determining as satisfying the design condition.

An aspect of the technology provides a non-transitory computer readable medium having an intake designing program that designs a shape of an intake of an aircraft. The intake designing program causes, when executed by a computer, the computer to implement a method. The method includes: setting a value of a design parameter that is related to a design target on a basis of an input operation, in which the design target is directed to a front fuselage, a bump, and an intake duct of the aircraft, the front fuselage is positioned more forward of an airframe of the aircraft than the intake, and the bump is positioned in front of the intake; setting a shape of the design target on a basis of the set value of the design parameter; analyzing an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target; determining whether an analysis result obtained by the analyzing satisfies a preset design condition; updating the value of the design parameter when the analysis result obtained by the analyzing is determined by the determining as not satisfying the design condition; and repeating the setting the shape of the design target, the analyzing, the determining, and the updating the value of the design parameter, until the analysis result obtained by the analyzing is determined by the determining as satisfying the design condition.

An aspect of the technology provides an intake designing apparatus configured to design a shape of an intake of an aircraft. The intake designing apparatus includes: a design parameter setting unit configured to set a value of a design parameter that is related to a design target on a basis of an input operation, in which the design target is directed to a front fuselage, a bump, and an intake duct of the aircraft, the front fuselage is positioned more forward of an airframe of the aircraft than the intake, and the bump is positioned in front of the intake; a shape setting unit configured to set a shape of the design target on a basis of the set value of the design parameter; an analyzer configured to analyze an aerodynamic characteristic and a radar cross-section characteristic of the design target, through creating, on a basis of the shape of the design target set by the shape setting unit, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target; a determiner configured to determine whether an analysis result obtained by the analyzer satisfies a preset design condition; and a design parameter updating unit configured to update the value of the design parameter when the analysis result obtained by the analyzer is determined by the determiner as not satisfying the design condition. The shape setting unit is configured to set the shape of the design target, the analyzer is configured to analyze the aerodynamic characteristic and the radar cross-section characteristic of the design target, the determiner is configured to determine whether the analysis result satisfies the preset design condition, and the design parameter updating unit is configured to update the value of the design parameter, until the determiner determines that the analysis result obtained by the analyzer satisfies the design condition.

An aspect of the technology provides an intake designing apparatus configured to designs a shape of an intake of an aircraft. The intake designing apparatus includes circuitry configured to set a value of a design parameter that is related to a design target on a basis of an input operation, in which the design target is directed to a front fuselage, a bump, and an intake duct of the aircraft, the front fuselage is positioned more forward of an airframe of the aircraft than the intake, and the bump is positioned in front of the intake, set a shape of the design target on a basis of the set value of the design parameter, analyze an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target, determine whether an analysis result obtained by the analyzing satisfies a preset design condition, update the value of the design parameter when the analysis result obtained by the analyzing is determined by the determining as not satisfying the design condition, and repeat the setting the shape of the design target, the analyzing, the determining, and the updating the value of the design parameter, until the analysis result obtained by the analyzing is determined by the determining as satisfying the design condition.

### BRIEF DESCRIPTION OF THE DRAWINGS

FIG. 1 is a block diagram illustrating an example of a functional configuration of an intake designing apparatus according to one implementation of the technology.

FIG. 2 is a diagram describing an example of a design target in performing an intake designing process according to one implementation.

FIG. 3 is a flowchart illustrating an example of a flow of the intake designing process according to one implementation.

FIG. 4 is a diagram describing an example of a method of setting a bump shape.

FIGS. 5A to 5C each illustrate an example of a response surface.

### DETAILED DESCRIPTION

In the following, a description is given of one implementation of the technology with reference to the accompanying drawings. Note that the following description is directed to illustrative examples of the disclosure and not to be construed as limiting to the technology. Factors including, without limitation, numerical values, shapes, materials, components, positions of the components, and how the components are coupled to each other are illustrative only and not to be construed as limiting to the technology. Further, elements in the following example implementations which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

In general, besides aerodynamic characteristics, low observability that bears a trade-off relationship to the aerodynamic characteristics is sometimes expected as well in designing of an intake. The low observability is, in other words, a level of difficulty of suffering detection by a detector such as radar. What is therefore desired is a proposal on a technique that achieves both the aerodynamic characteristics and the low observability.

It is desirable to allow for suitable designing of a shape of a diverterless intake while taking an influence of a shape of a front fuselage into consideration and achieving both an aerodynamic characteristic and low observability.

### [Configuration of Intake Designing Apparatus]

First, a description is given of a configuration of an intake designing apparatus 1 according to one implementation.

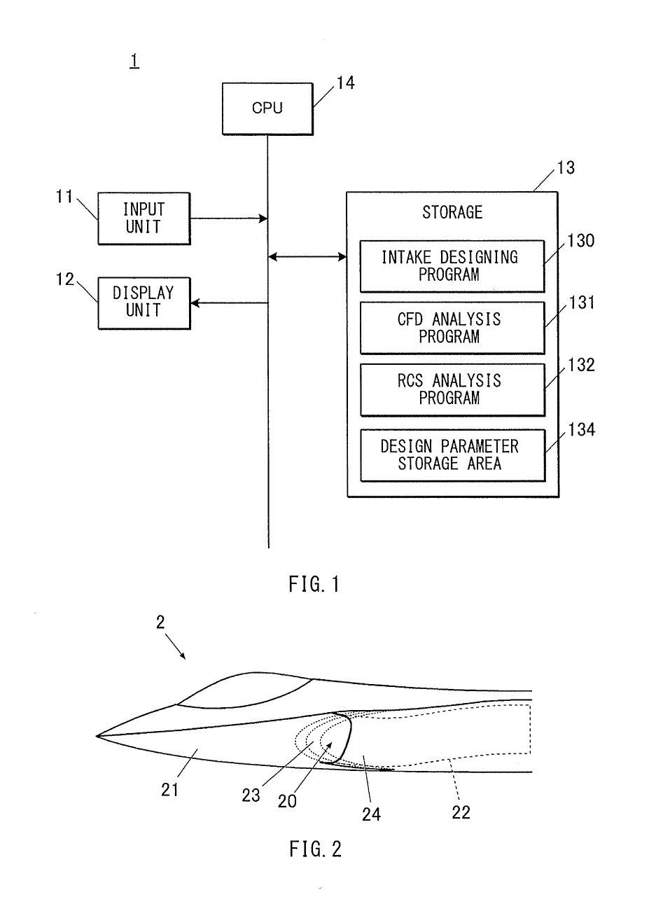

FIG. 1 illustrates an example of a functional configuration of the intake designing apparatus 1.

The intake designing apparatus 1 according to one implementation may be an information processor that sets a shape of a diverterless intake of an aircraft. Referring to FIG. 1, the intake designing apparatus 1 may include an input unit 11, a display unit 12, a storage 13, and a central processing unit (CPU) 14.

The input unit 11 may include various unillustrated input keys. The input unit 11 may output, to the CPU 14, an input signal corresponding to a position of the key pressed by a user. In an alternative implementation, the input unit 11 may be a touch panel.

The display unit 12 may include an unillustrated display. The display unit 12 may display various pieces of information on the display, on the basis of a display signal supplied from the CPU 14.

The storage 13 may include a memory such as a random access memory (RAM), a read only memory (ROM), or a computer readable medium. The storage 13 may contain various programs and pieces of data, and may also serve as a work area of the CPU 14. In one implementation, the storage 13 may store an intake designing program 130, a computational fluid dynamics (CFD) analysis program 131, and a radar cross-section (RCS) analysis program 132.

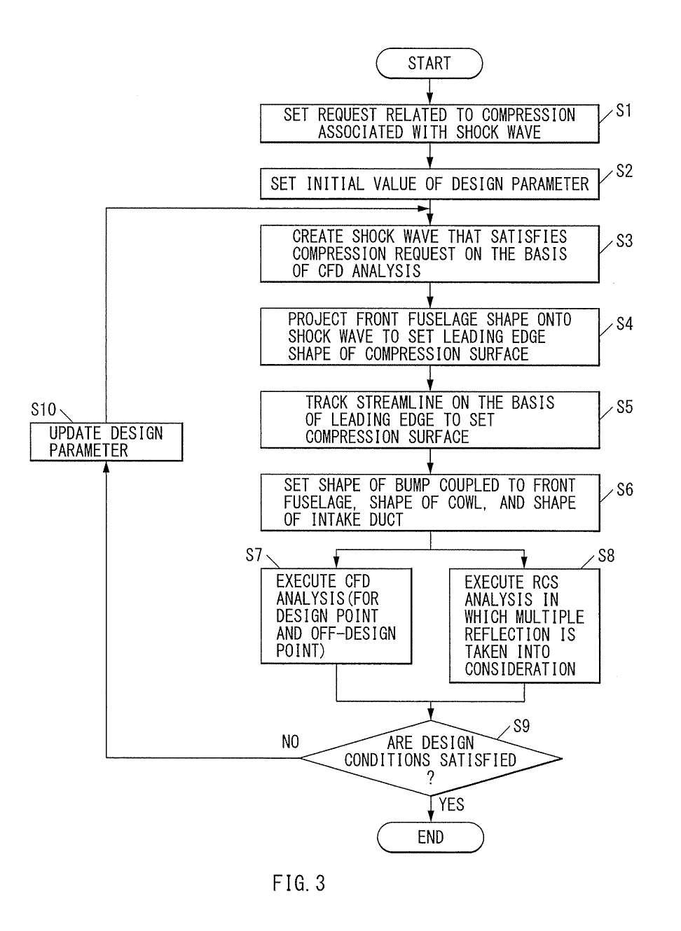

The intake designing program 130 may be a program that causes the CPU 14 to execute a later-described intake designing process illustrated by way of example in FIG. 3.

The CFD analysis program 131 may be software directed to a CFD analysis. The CFD analysis software may calculate an aerodynamic characteristic of a design target.

The RCS analysis program 132 may be software directed to an electromagnetic analysis. The electromagnetic analysis software may calculate an RCS characteristic of the design target. The RCS is a parameter that represents, in a quantitative fashion, low observability, i.e., a level of difficulty of suffering detection by a detector such as radar. The smaller a value of the RCS becomes, the lower the low observability indicated by the RCS. In other words, the term “RCS characteristic” as used herein refers to low observability in terms of radio wave.

The storage 13 may also contain unillustrated three-dimensional computer-aided design (CAD) software. The three-dimensional CAD software may create an analytical model directed to the CFD analysis program 131 and an analytical model directed to the RCS analysis program 132.

The storage 13 may have a design parameter storage area 134. The design parameter storage area 134 may be a memory region directed to storing of a design parameter used in the later-described intake designing process.

The CPU 14 may execute, in accordance with a received instruction, a process that is based on a predetermined program to thereby perform operations including giving instructions to respective functional units and transferring pieces of data to the respective functional units. By executing the process and performing the operations, the CPU 14 may control the intake designing apparatus 1 in an overall fashion. For example, the CPU 14 may read out various programs from the storage 13 in accordance with an operation signal received from the input unit 11 and/or any other signal, and may execute a process in accordance with the read-out programs. The CPU 14 may also cause the storage 13 to temporarily hold a processing result, and may output the processing result to the display unit 12 on an as-needed basis.

In one implementation, the CPU 14 may serve as a “design parameter setting unit”, a “shape setting unit”, an “analyzer”, a “determiner”, and a “design parameter updating unit”.

### [Operation of Intake Designing Apparatus]

A description is given next of an operation of the intake designing apparatus 1 upon executing the intake designing process.

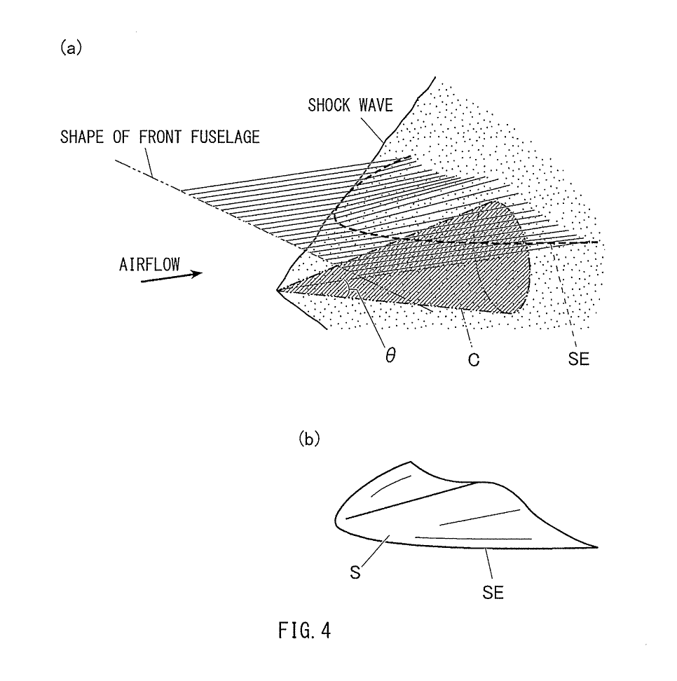

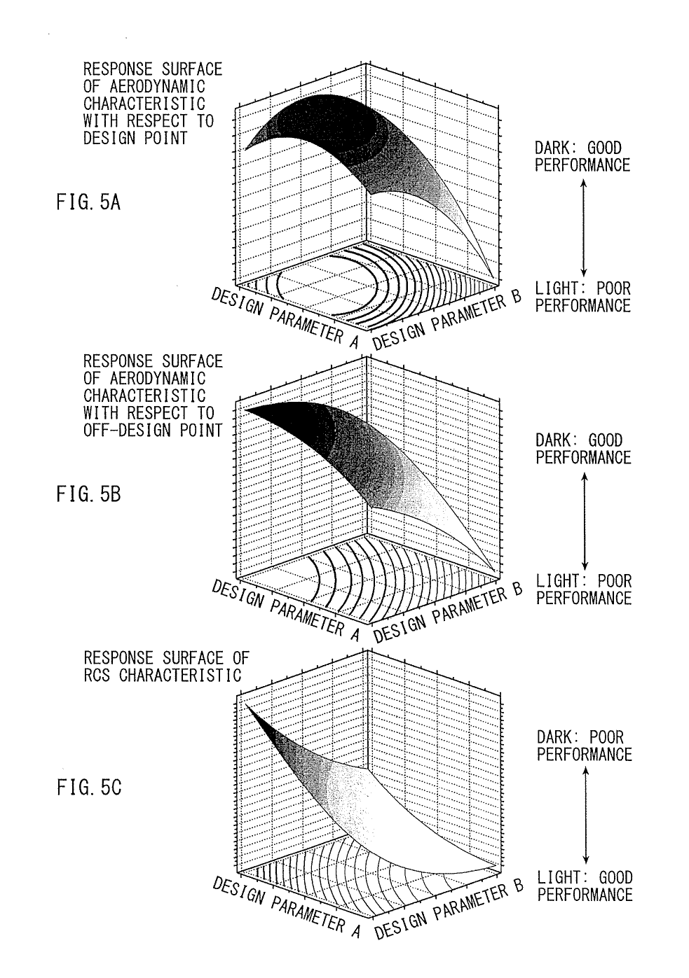

FIG. 2 describes an example of the design target in performing the intake designing process. FIG. 3 illustrates an example of a flow of the intake designing process. FIG. 4 describes an example of a method of setting a bump shape. FIG. 5A to FIG. 5C each illustrate an example of a later-described response surface.

Referring to FIG. 2, the intake designing process may allow for designing of a shape of an aircraft 2 in consideration of both the aerodynamic characteristics and the RCS characteristic, i.e., the low observability. In an example implementation, the intake designing process may allow for designing of a shape, from a front fuselage 21 across an intake duct 22, of the aircraft 2. The front fuselage 21 may be positioned more forward of an airframe than the intake 20. In a specific but non-limiting implementation, the intake designing process may set, as the design target or a “design range”, a shape of a peripheral part of the intake 20 in addition to the front fuselage 21 and the intake duct 22. For example, the peripheral part of the intake 20 may include a bump 23 and a cowl 24. The bump 23 may be a smooth protrusion, and may be provided on a surface of the airframe in a region from a part immediately in front of the intake 20 to an entrance of the intake 20. The bump 23 may create a pressure gradient and thereby suppress flowing of a boundary layer into the intake 20.

For example, the intake designing process may be executed in response to an input of instructions directed to the execution of the intake designing process. The input of the instructions may be based on an operation performed by the user. Upon receiving the input of the instructions, the CPU 14 may read out the intake designing program 130 from the storage 13 and expand the intake designing program 130 to thereby execute the intake designing process.

The three-dimensional CAD software may be used to set a three-dimensional shape upon setting a shape of each part in the intake designing process. When setting the shape of each part, a non-uniform rational basis spline (NURBS) mathematical function may be used to create a shape of a curve and a shape of a curved surface of any part. For example, a shape of a curve and a shape of a curved surface of a connection surface of each part may be created on the basis of the NURBS.

Referring to FIG. 3, upon the execution of the intake designing process, the CPU 14 may first set a request related to compression at the bump 23 associated with a shock wave (step S1). The CPU 14 may set the compression request on the basis of an operation performed by the user.

Thereafter, the CPU 14 may set an initial value of the design parameter (step S2). The CPU 14 may set the initial value of the design parameter on the basis of an operation performed by the user.

For example, in step S2, the CPU 14 may set, on an as-needed basis, an initial value for each of a shape parameter of the front fuselage 21 and a design parameter of the bump 23. Referring to (a) of FIG. 4, the design parameter of the bump 23 may include parameters related to an angle θ of a virtual cone C by which the shock wave is generated, to a position of projection of a shape of the front fuselage 21, and to a shape of the connection surface. The angle θ of the virtual cone C may be defined as an angle between a central axis and a generatrix.

The CPU 14 may further receive the initial value of the design parameter inputted by the user, and may store the initial value of the design parameter in the design parameter storage area 134.

Thereafter, on the basis of the CFD analysis, the CPU 14 may so create the shock wave associated with the virtual cone C as to satisfy the compression request set in step S1 (step S3).

For example, in step S3, the CPU 14 may so determine the angle θ of the virtual cone C as to satisfy the compression request set in step S1, and may thereafter obtain, on the basis of the CFD analysis, the shock wave that is based on the determined angle θ. The CFD analysis performed to obtain the shock wave may be based on the CFD analysis program 131.

Thereafter, the CPU 14 may project the shape of the front fuselage 21 onto the shock wave obtained in step S3 and set a shape of a leading edge SE of a compression surface S (step S4).

Thereafter, the CPU 14 may track a streamline on the basis of the leading edge SE of the compression surface S set in step S4, and define a shape of the streamline as the compression surface S (step S5) as illustrated in (b) of FIG. 4.

Thereafter, the CPU 14 may determine a shape of each of the bump 23, the cowl 24, and the intake duct 22 (step S6). The CPU 14 may determine the respective shapes on the basis of an operation performed by the user.

For example, in step S6, the CPU 14 may so determine the shape of the bump 23 as to couple from the compression surface S to a throat, and may also determine the shapes of the respective cowl 24 and intake duct 22 on the basis of predetermined conditions. The throat is, in other words, a region with the minimum area inside the intake duct 22.

The CPU 14 may thus create shape data of the design target including the front fuselage 21, the bump 23, the cowl 24, and the intake duct 22.

Thereafter, the CPU 14 may execute, using the shape data created in step S6, the CFD analysis and the RCS analysis.

For example, the CPU 14 may execute the CFD analysis through generating an analytical grid and creating the CFD analytical model, on the basis of the CFD analysis program 131 (step S7). In an example implementation, the CFD analysis may include an analysis performed for a design point that is based on a supersonic region and an analysis performed for an off-design point that is based on a subsonic region and based on a condition of a high elevation angle or a high sideslip angle. The analysis based on the shapes, including the shape of the front fuselage 21, is performed in the CFD analysis, making it possible to appropriately add, to the CFD analysis, an influence of development of the boundary layer at the front fuselage 21. It is to be noted that the off-design point is not limited to the off-design point based on the subsonic region. The off-design point may be any off-design point, as long as such an off-design point is based on conditions where an airframe speed is lower than the airframe speed in the design point, and where the elevation angle or the sideslip angle of the airframe is larger than the elevation angle or the sideslip angle of the airframe in the design point.

Further, the CPU 14 may execute the RCS analysis in which multiple reflection is taken into consideration through generating an analytical grid and creating the RCS analytical model, on the basis of the RCS analysis program 132 (step S8). In an example implementation, step S8 may be executed simultaneously with step S7. In an alternative example implementation, step S8 may be executed at timing different from timing at which step S7 is executed. The analysis based on the shapes, including the shape of the front fuselage 21, is performed in the RCS analysis, making it possible to reflect an influence of deflection, in path, of the radio wave associated with the front fuselage 21 and thereby making it possible to take into consideration appropriately a path along which the multiple reflection occurs inside the intake duct 22.

In one implementation, the aerodynamic characteristics including a total pressure recovery ratio, distortion, and spillage drag may be calculated by the CFD analysis. Further, in one implementation, the RCS may be calculated by the RCS analysis.

Thereafter, the CPU 14 may determine whether an analysis result obtained on the basis of the CFD analysis and the RCS analysis satisfies predetermined design conditions (step S9).

For example, the design conditions related to the aerodynamic characteristics, including the total pressure recovery ratio, the distortion, and the spillage drag, may be set in advance for a result to be obtained by the CFD analysis. The design conditions related to the aerodynamic characteristics may be set in advance for each of the design point and the off-design point. Further, the design conditions related to the RCS may be set in advance for a result to be obtained by the RCS analysis.

In an alternative example implementation, upon determining the design conditions, the CPU 14 may calculate, on the basis of the obtained analysis result, a target mathematical function, and may determine whether the design conditions are satisfied on the basis of the target mathematical function. The target mathematical function may be represented as the sum of the weighted aerodynamic characteristics and the weighted RCS characteristic.

When the CPU 14 determines in step S9 that the analysis result obtained on the basis of the CFD analysis and the RCS analysis fails to satisfy any of the design conditions (step S9: NO), the CPU 14 may update the design parameter stored in the design parameter storage area 134 (step S10). The process may proceed to the foregoing step S3 after the CPU 14 has updated the design parameter.

For example, the CPU 14 may so update the design parameter as to bring the analysis result obtained on the basis of the CFD analysis and the RCS analysis closer to the satisfaction of the design conditions. In an example implementation, a gradient method, a response surface methodology, or any other optimization method may be used to so update the design parameter, while optimizing the design parameter, that a solution satisfying the design conditions is obtained. Referring to FIGS. 5A to 5C, the response surface methodology is a technique in which a response surface of each of the aerodynamic characteristics and the RCS characteristic is generated in advance for each design parameter, and in which a shape of the design target is determined on the basis of the response surfaces. In an example implementation where the response surface methodology is used, a solution of the design parameter satisfying the design conditions is explored on the basis of the response surfaces. In such an example implementation, values obtained on the basis of the response surfaces, following the execution of the analysis with use of the design parameter, may be compared with the design conditions, and an additional value directed to updating of the response surfaces may be set for the design parameter when the values obtained on the basis of the response surfaces do not come into favorable coincidence with the design conditions. By setting the additional value for the design parameter, the response surfaces may be updated with use of a result of the analysis performed on the basis of the additional value of the design parameter.

Accordingly, the creation of the shape data of the design target, the CFD analysis, the RCS analysis, the determination on the satisfaction of the design conditions, and the updating of the design parameter may be repeated until the analysis result obtained on the basis of the CFD analysis and the RCS analysis satisfies the design conditions.

When the CPU 14 determines in step S9 that the analysis result obtained on the basis of the CFD analysis and the RCS analysis satisfies the design conditions (step S9: YES), the CPU 14 may end the intake designing process after performing any operation. For example, the CPU 14 may end the intake designing process after outputting a result of the process to the display unit 12.

### Example Effects

According to the foregoing example implementation, the analysis on the aerodynamic characteristics and the RCS characteristic of the design target, directed to the front fuselage 21, the bump 23, and the intake duct 22, is repeated with the design parameter related to the design target being updated on an as-needed basis, until the aerodynamic characteristics and the RCS characteristic of the design target satisfy the predetermined design conditions. The RCS characteristic is, in other words, the low observability.

Hence, it is possible to suitably design the shape of the intake 20 while taking an influence of the shape of the front fuselage 21 into consideration and achieving both the aerodynamic characteristics and the low observability.

Incidentally, a designing technique disclosed in above-described U.S. Pat. No. 5,779,189 is silent as to the influence of the development of the boundary layer at the front fuselage in the off-design point.

In contrast, the foregoing example implementation, as described above, makes it possible to suitably design the shape of the diverterless intake while taking the influence of the shape of the front fuselage 21 into consideration and achieving both the aerodynamic characteristic and the low observability.

Further, the aerodynamic characteristics may be calculated for the design point that is based on the airframe speed in the supersonic region, and for the off-design point that is based on the airframe speed less than the airframe speed in the design point and based on the elevation angle or the sideslip angle of the airframe greater than the elevation angle or the sideslip angle in the design point.

Hence, it is possible to design the shape of the intake 20 that suitably satisfies the design conditions, even for the off-design point where an orientation of the airframe relative to an airflow varies from the orientation in the design point and where a state of development of the boundary layer at the front fuselage 21 varies from the state of development in the design point.

The CPU 14 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the CPU 14. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the CPU 14 illustrated in FIG. 1.

Although some preferred implementations of the technology have been described in the foregoing by way of example with reference to the accompanying drawings, the technology is by no means limited to the implementations described above. It should be appreciated that modifications and alterations may be made by persons skilled in the art without departing from the scope as defined by the appended claims. The technology is intended to include such modifications and alterations in so far as they fall within the scope of the appended claims or the equivalents thereof.

1. An intake designing method that designs a shape of an intake of an aircraft, the method comprising:
setting a value of a design parameter that is related to a design target on a basis of an input operation, the design target being directed to a front fuselage, a bump, and an intake duct of the aircraft, the front fuselage being positioned more forward of an airframe of the aircraft than the intake, the bump being positioned in front of the intake;
setting a shape of the design target on a basis of the set value of the design parameter;
analyzing an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target;
determining whether an analysis result obtained by the analyzing satisfies a preset design condition;
updating the value of the design parameter when the analysis result obtained by the analyzing is determined by the determining as not satisfying the design condition; and
repeating the setting the shape of the design target, the analyzing, the determining, and the updating the value of the design parameter, until the analysis result obtained by the analyzing is determined by the determining as satisfying the design condition.

2. The intake designing method according to claim 1, wherein the aerodynamic characteristic of the design target related to a design point and the aerodynamic characteristic of the design target related to an off-design point are calculated in the analyzing, the design point being based on a first airframe speed that is in a supersonic region, the off-design point being based on a second airframe speed that is less than the first airframe speed, and being based on an elevation angle or an sideslip angle of the airframe relatively greater than an elevation angle or a sideslip angle of the airframe in the design point.

3. The intake designing method according to claim 1, wherein the updating the value of the design parameter includes optimizing the design parameter to allow a solution that satisfies the design condition to be obtained.

4. The intake designing method according to claim 2, wherein the updating the value of the design parameter includes optimizing the design parameter to allow a solution that satisfies the design condition to be obtained.

5. The intake designing method according to claim 1, wherein the design target includes a cowl of the intake.

6. The intake designing method according to claim 2, wherein the design target includes a cowl of the intake.

7. The intake designing method according to claim 3, wherein the design target includes a cowl of the intake.

8. The intake designing method according to claim 4, wherein the design target includes a cowl of the intake.

9. A non-transitory computer readable medium having an intake designing program that designs a shape of an intake of an aircraft, the intake designing program causing, when executed by a computer, the computer to implement a method, the method comprising:
setting a value of a design parameter that is related to a design target on a basis of an input operation, the design target being directed to a front fuselage, a bump, and an intake duct of the aircraft, the front fuselage being positioned more forward of an airframe of the aircraft than the intake, the bump being positioned in front of the intake;
setting a shape of the design target on a basis of the set value of the design parameter;
analyzing an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target;
determining whether an analysis result obtained by the analyzing satisfies a preset design condition;
updating the value of the design parameter when the analysis result obtained by the analyzing is determined by the determining as not satisfying the design condition; and
repeating the setting the shape of the design target, the analyzing, the determining, and the updating the value of the design parameter, until the analysis result obtained by the analyzing is determined by the determining as satisfying the design condition.

10. An intake designing apparatus configured to design a shape of an intake of an aircraft, the intake designing apparatus comprising:
a design parameter setting unit configured to set a value of a design parameter that is related to a design target on a basis of an input operation, the design target being directed to a front fuselage, a bump, and an intake duct of the aircraft, the front fuselage being positioned more forward of an airframe of the aircraft than the intake, the bump being positioned in front of the intake;
a shape setting unit configured to set a shape of the design target on a basis of the set value of the design parameter;
an analyzer configured to analyze an aerodynamic characteristic and a radar cross-section characteristic of the design target, through creating, on a basis of the shape of the design target set by the shape setting unit, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target;
a determiner configured to determine whether an analysis result obtained by the analyzer satisfies a preset design condition; and
a design parameter updating unit configured to update the value of the design parameter when the analysis result obtained by the analyzer is determined by the determiner as not satisfying the design condition,
the shape setting unit being configured to set the shape of the design target, the analyzer being configured to analyze the aerodynamic characteristic and the radar cross-section characteristic of the design target, the determiner being configured to determine whether the analysis result satisfies the preset design condition, and the design parameter updating unit being configured to update the value of the design parameter, until the determiner determines that the analysis result obtained by the analyzer satisfies the design condition.

11. An intake designing apparatus configured to designs a shape of an intake of an aircraft, the intake designing apparatus comprising
circuitry configured to
set a value of a design parameter that is related to a design target on a basis of an input operation, the design target being directed to a front fuselage, a bump, and an intake duct of the aircraft, the front fuselage being positioned more forward of an airframe of the aircraft than the intake, the bump being positioned in front of the intake,
set a shape of the design target on a basis of the set value of the design parameter,
analyze an aerodynamic characteristic and a radar cross-section characteristic of the design target, through creating, on a basis of the set shape of the design target, an analytical model directed to an analysis of the aerodynamic characteristic and an analytical model directed to an analysis of the radar cross-section characteristic, and through calculating, on a basis of the created analytical models, the aerodynamic characteristic and the radar cross-section characteristic of the design target,
determine whether an analysis result obtained by the analyzing satisfies a preset design condition,
update the value of the design parameter when the analysis result obtained by the analyzing is determined by the determining as not satisfying the design condition, and
repeat the setting the shape of the design target, the analyzing, the determining, and the updating the value of the design parameter, until the analysis result obtained by the analyzing is determined by the determining as satisfying the design condition.
